(19) United States
(12) Patent Application Publication
(10) Pub. No.: US 2008/0037379 A1
(43) Pub. Date: Feb. 14, 2008

(54) OPTICAL DISK DEVICE AND METHOD FOR GENERATING RANDOM NUMBER DATA

(76) Inventor: Shinichiro Arakawa, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/690,991

(22) Filed: Mar. 26, 2007

(30) Foreign Application Priority Data
Mar. 31, 2006 (JP) 2006-099366

(51) Int. Cl. G11B 7/00

(52) U.S. Cl. 369/44.11

(57) ABSTRACT

An optical disk device includes a signal processing unit which processes a signal output by a pickup head, an amplifying unit which amplifies the signal processed by the signal processing unit, an analog to digital converting unit which converts the signal concerning a white noise amplified by the amplifying unit into a digital signal to output data of a particular bit width, and a random number data generating unit which generates random number data on the basis of the data output by the analog to digital converting unit.

### CROSS-REFERENCE TO RELATED APPLICATIONS

This application is based upon and claims the benefit of priority from prior Japanese Patent Application No. 2006-099366, filed Mar. 31, 2006, the entire contents of which are incorporated herein by reference.

### BACKGROUND OF THE INVENTION

1. Field of the Invention

The present invention relates to an optical disk device and a method for generating random number data.

2. Description of the Related Art

If a content protecting technique such as Content Scramble System (CSS), Advanced Access Control System (AACS), Content Protection For Recordable Media (CPRM), or Video Content Protection System (VCPS) is used for an optical disk device, random number data is required to encrypt a secret key when authenticating the device to a host. To avoid cracks by malicious users, the random number data needs to be in a high grade, for example, to be non-reproducible.

A well-known random number generator generating random number data utilizes random pulses based on a physical phenomenon such as white noise. For example, a random number generator described in Jpn. Pat. Appln. KOKAI Publication No. 2003-150374 has a noise source, an amplifier that amplifies noise, a reference pulse signal, a pulse width modulating circuit that randomly varies pulse width depending on noise level and on the basis of the reference pulse signal, and a random number generating circuit that compares the 0 or 1 status of an output pulse from the pulse width modulating circuit with the 0 or 1 status of the reference pulse signal to generate random data “0” or “1”.

The conventional random number generator requires the noise source, which generates random pulses such as white noise, and an additional circuit such as the amplifying circuit. The conventional random number generator also requires amplification of a fine signal such as the white noise, generated by the noise source. This results in the need for extra power consumption dedicated to generation of random number data.

The other prior art uses a pseudo-random number generator that uses logical circuits to generate pseudo-random numbers. The pseudo-random number generator does not require any additional circuit but presents a problem with the grade of random number data; the same pattern of random numbers is generated every time unless the initial value is specially set.

### BRIEF SUMMARY OF THE INVENTION

According to an aspect of the present invention, there is provided an optical disk device comprising: a signal processing unit which processes a signal output by a pickup head; an amplifying unit which amplifies the signal processed by the signal processing unit; an analog to digital converting unit which converts the signal concerning a white noise amplified by the amplifying unit into a digital signal to output data of a particular bit width; and a random number data generating unit which generates random number data on the basis of the data output by the analog to digital converting unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a system according to an embodiment of the present invention;

FIG. 2 is a diagram showing the details of configuration of a photodetector in a pickup head and a head amplifier according to the present embodiment;

FIG. 3 is a diagram showing an example of 8-bit data output by an analog to digital converter according to the present embodiment;

FIG. 4 is a flowchart illustrating a first random number generating process according to the present embodiment;

FIG. 5 is a diagram illustrating the first random number generating process according to the present embodiment;

FIG. 6 is a flowchart illustrating a second random number generating process according to the present embodiment;

FIG. 7 is a diagram illustrating the second random number generating process according to the present embodiment; and

FIG. 8 is a block diagram showing the configuration of a random number generating unit that generates pseudo-random number data according to the present embodiment.

### DETAILED DESCRIPTION OF THE INVENTION

An embodiment of the present invention will be described with reference to the drawings.

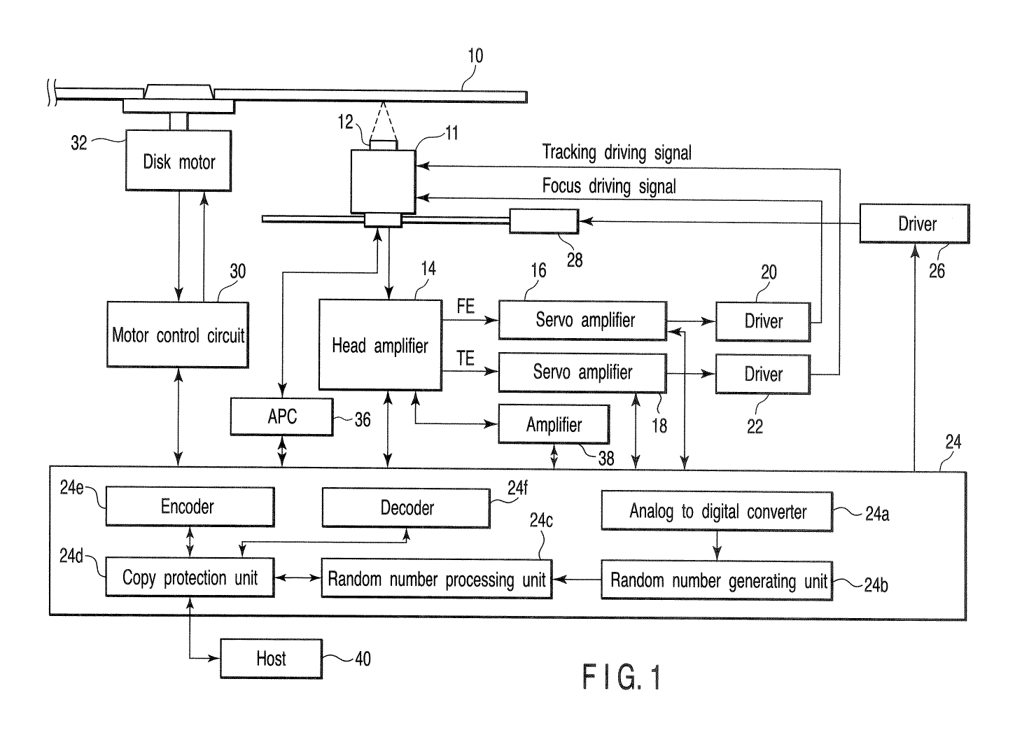

FIG. 1 is a block diagram showing the configuration of a system according to the present embodiment.

An optical disk 10 as recording media has spiral tracks formed and is rotatively driven by a disk motor 32 (for example, a spindle motor).

Data is recorded on and reproduced from the optical disk 10 via laser beams output by a pickup head (PUH) 11 (optical pickup head). The pickup head 11 is supported opposite a data read surface of the optical disk 10 so as to be movable in a radial direction of the optical disk 10 by a feed motor 28.

The pickup head 11 includes a laser diode, a collimator lens, a beam splitter, an object lens 12, a cylindrical lens, a photodetector, a lens position sensor, and a monitor diode.

The pickup head 11 is provided with a two-axis actuator that moves the object lens 12 in two orthogonal directions, that is, a focus actuator that moves the object lens 12 in a focusing direction (direction of optical axis of the lens) and a tracking actuator that moves the object lens 12 in a tracking direction (radial direction of the optical disk 10) to adjust tracking. The focus actuator is controlled by a focus driving signal output by a driver 20. The tracking actuator is controlled by a tracking driving signal from a driver 22.

The laser diode is driven by auto power control unit (APC) 36 under the control of a controller 24 to output a laser beam. The laser beam output by the laser diode is applied to the optical disk 10 via the collimator lens, a beam splitter, and the object lens 12.

The reflected beam from the optical disk 10 is guided to the photodetector via the object lens 12, beam splitter, and cylindrical lens. The photodetector is divided into, for example, four segments. A signal sensed by the photodetector, divided into four segments, is amplified to a predetermined voltage value. The amplified signal is then output to a head amplifier 14.

The APC 36 drives the laser diode under the control of the controller 24 and controls the on and off of a laser beam output and the intensity of a laser beam during reproduction or recording.

The laser beam output by the laser diode is applied to the optical disk 10 via the collimator lens, beam splitter, and object lens 12. The laser beam reflected by the optical disk 10 is guided to the photodetector (photodetectors 11a, 11b, 11c, and 11d) via the object lens 12, beam splitter, and cylindrical lens.

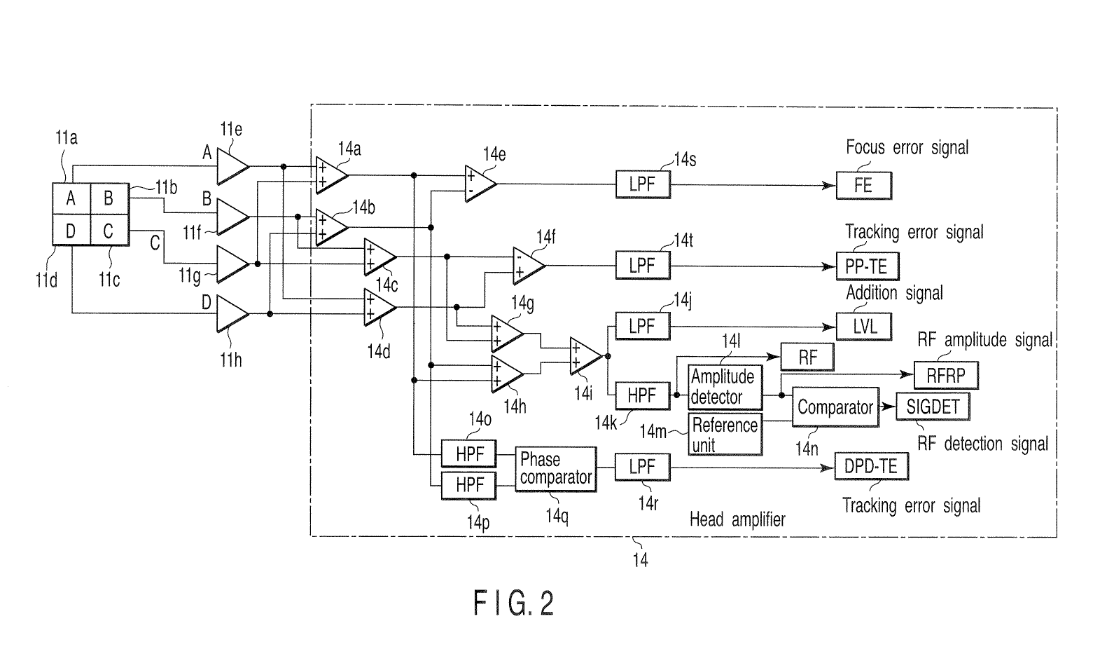

The head amplifier 14 (signal processing circuit) is a conventional circuit provided in the optical disk device. The head amplifier 14 processes signals from the photodetector and outputs the resulting signal. The head amplifier 14 generates and outputs a tracking error signal (TE) indicating an error between the beam spot center of the laser beam, a focus error signal (FE) indicating an error from a just focus, an RF signal or addition signal (focus sum signal) obtained by adding together signals output by the four segments of the photodetector (this will be described later in detail (see FIG. 2)).

The focus error signal FE output by the head amplifier 14 is output to a servo amplifier 16. The tracking error signal TE (DPD-TE signal or PP-TE signal) is output to a servo amplifier 18.

The servo amplifier 16 amplifies the focus error signal FE output by the head amplifier 14. The servo amplifier 16 causes the driver 20 to output the focus driving signal to the focusing actuator (not shown) in the pickup head 11. The signal amplified by the servo amplifier 16 is output to an analog to digital converter 24a in the controller 24.

The focus driving signal output by the driver 20 drives the focusing actuator, which executes focus servo so that the laser beam output by the pickup head 11 just focuses on a recording film of the optical disk 10.

The servo amplifier 18 amplifies the tracking error signal TE output by the head amplifier 14. The servo amplifier 18 causes the driver 22 to output the tracking driving signal to the tracking actuator (not shown) in the pickup head 11. The signal amplified by the servo amplifier 18 is output to the analog to digital converter 24a in the controller 24.

The tracking driving signal output by the driver 22 drives the tracking actuator, which executes tracking servo so that the laser beam output by the pickup head 11 always traces any of the tracks formed on the optical disk 10.

The amplifier 38 amplifies an analog signal output by the head amplifier 14, for example, the RF signal, the addition signal (focus sum signal) LVL, or a wobble signal. The amplifier 38 then outputs the amplified signal to the analog to digital converter 24a in the controller 24.

The servo amplifiers 16 and 18 and the amplifier 38 are conventional circuits provided in the optical disk device.

The controller 24 includes processors and memories (RAM, ROM, and the like) and integrally controls the entire device by allowing the processors to execute various memories stored in the memories. The controller 24 is provided with a function for protecting a copyright for the contents recorded in the optical disk. A content protecting technique such as CSS, AACS, CPRM, or VCPS is utilized to protect the copyright for the contents.

For processes utilizing the content protecting technique, the controller 24 is provided with the analog to digital converter 24a, a random number generating unit 24b, a random number processing unit 24c, a copy protection unit 24d, an encoder 24e, and a decoder 24f.

The analog to digital converter 24a is a conventional circuit that causes the controller 24 to execute a process corresponding to a signal output by the head amplifier 14. An analog signal output by the head amplifier 14 is input, via the amplifier (servo amplifier 16 or 18 or amplifier 38), to the analog to digital converter 24a, which then converts the signal into a digital one. The analog to digital converter 24a outputs digital data of, for example, an 8-bit width. The analog to digital converter 24a may output digital data of a data width other than 8 bits.

The optical disk device according to the present embodiment performs the following operation to generate random number data using a signal path through which the head amplifier 14 outputs the tracking error signal (DPD-TE). A analog signal amplified by the servo amplifier 18 is first input to the analog to digital converter 24a. The analog to digital converter 24a then executes an analog to digital conversion on the amplified signal and outputs digital data resulting from the analog to digital conversion to the random number generating unit 24b.

The random number generating unit 24b generates random number data required to cipher key information (for example, a secret key) used for the content protecting technique, on the basis of the digital data of a particular bit width (for example, 8 bits) output by the analog to digital converter 24a.

The random number processing unit 24c uses the random number data generated by the random number generating unit 24b to cipher the key information used for a process utilizing the content protecting technique, thus generating a ciphered key.

The copy protection unit 24d uses the content protecting technique such as CSS, AACS, CPRM, or VCPS to execute a process for protecting the copyright for the contents recorded in the optical disk 10. The copy protection unit 24d generates and outputs key information to the random number processing unit 24c to acquire the ciphered key generated by the random number generating unit 24c. The copy protection unit 24d uses the ciphered key generated by the random number generating unit 24c to execute, for example, an instrument authenticating process for a host computer 40. The copy protection unit 24d further provides the ciphered key to the encoder 24e or decoder 24f.

To record contents in the recordable optical disk 10, the encoder 24e uses the ciphered key obtained from the copy protection unit 24d to cipher content data.

To read the contents recorded in the optical disk 10, the decoder 24 uses the ciphered key obtained from the copy protection unit 24d to decode the ciphered content data read from the optical disk 10.

FIG. 2 is a diagram showing the details of configuration of the photodetector (11a, 11b, 11c, and 11d) in the pickup head 11 and the head amplifier 14.

Signals A to D detected by the four segments 11a, 11b, 11c, and 11d of the photodetector are amplified by amplifiers 11e, 11f, 11g, and 11h provided in the pickup head 11, so as to have predetermined voltage values.

The signal A output by the amplifier 11e is input to adders 14a and 14b in the head amplifier 14. The signal B output by the amplifier 11f is input to the adders 14b and 14c in the head amplifier 14. The signal C output by the amplifier 11g is input to the adders 14a and 14c in the head amplifier 14. The signal D output by the amplifier 11h is input to the adders 14b and 14d in the head amplifier 14. Consequently, the adder 14a adds the signals A and C together to output a signal (A+C). Similarly, the adder 14b outputs a signal (B+D), the adder 14c outputs a signal (B+C), and the adder 14d outputs a signal (A+D).

The signal (A+C) output by the adder 14a is input to a subtractor 14e, an adder 14h, and high pass filter (HPF) 14o. The signal (B+D) output by the adder 14b is input to the subtractor 14e, the adder 14h, and HPF 14p. The signal (B+C) output by the adder 14c is input to a subtractor 14f and an adder 14g. The signal (A+D) output by the adder 14d is input to the subtractor 14f and the adder 14g.

The subtractor 14e subtracts the signal (B+D) output by the adder 14b from the signal (A+C) output by the adder 14a and outputs the resulting signal. The signal output by the subtractor 14e is output via low pass filter (LPF) 14s as a focus error signal (FE). In other words, the focus error signal FE=(A+C)−(B+D).

The subtractor 14f subtracts the signal (B+C) output by the adder 14c from the signal (A+D) output by the adder 14d and outputs the resulting signal. The signal output by the subtractor 14f is output via LPF 14t as a tracking error signal (PP-TE) based on a push pull method. In other words, the tracking error signal (PP-FE) based on the push pull method=(A+D)−(B+C).

The signal (A+C) output by the adder 14a is input to a phase comparator 14q via HPF 14o. The signal (B+D) from the adder 14b is input to the phase comparator 14q via HPF 14p. The phase comparator 14q then outputs a signal indicative of the phase difference between the two signals, that is, a signal obtained by subtracting the signal (B+D) from the signal (A+C). The signal output by the phase comparator 14q is output via LPF 14r as a tracking error signal (DPD (Differential Phase Detection)-TE) based on a phase difference method. In other words, the tracking error signal (DPD-TE) based on the phase difference method=φ(A+C)−φ(B+D).

The adder 14g adds the signal (A+D) output by the adder 14d to the signal (B+C) output by the adder 14c to output the resulting signal. The adder 14h adds the signal (A+C) output by the adder 14a to the signal (B+D) output by the adder 14d to output the resulting signal. An adder 14i adds the signal output by the adder 14g to the signal output by the adder 14h and outputs the resulting signal. In other words, the adder 14i adds all signals output by the photodetectors 11a, 11b, 11c, and 11d to output the resulting signal (A+B+C+D). The signal output by the adder 14i is output via LPF 14j as the addition signal (focus sum signal) LVL (hereinafter referred to as the LVL signal). The signal output by the adder 14i is also output via HPF 14k as the information signal RF (hereinafter referred to as the RF signal). The signal output via HPF 14k is input to an amplitude detector 14l, which then senses the amplitude value of the RF signal and outputs an RF amplitude signal RFRP varying in proportion to the amplitude value.

The RF amplitude signal output by the amplitude detector 14l is input to a comparator 14n, which then compares a reference value preset in a reference unit 14m with the level of the RF amplitude signal. If the level of the RF amplitude signal is higher than the reference value, the comparator 14n outputs an RF detection signal SIGDET (hereinafter referred to as a SIGDET signal).

The operation of the present embodiment will be described below with reference to the drawings.

In the present embodiment, description will be given of, by way of example, generation of random number data based on white noise output from the signal path through which the head amplifier 14 outputs the tracking error signal (DPD-TE).

During a normal operation for performing a data read or write operation on the optical disk 10, the optical disk device uses the servo amplifier 18 to amplify the tracking error signal (DPD-TE) output by the head amplifier 14. The optical disk device then outputs the tracking driving signal to the pickup head 11 via the driver 22. The tracking actuator in the pickup head 11 adjusts tracking in accordance with the track driving signal.

On the other hand, immediately after the optical disk device is powered on, that is, before APC 36 starts driving the laser diode in the pickup head 11, no light enters the photodetectors 11a, 11b, 11c, and 11d.

Without light, each of the photodetectors 11a, 11b, 11c, and 11d outputs white noise. The white noises output by the photodetectors 11a, 11b, 11c, and 11d are amplified by the amplifiers 11e, 11f, 11g, and 11h, respectively, as shown in FIG. 2.

The head amplifier 14 adds diagonal components of the white noises (signals (A+C) and (B+D)) together to generate a signal from the phase difference between the uncorrelated signals, which correspond to the added diagonal components, as shown in FIG. 2. As a result, the head amplifier 14 generates and outputs white noise that is random noise.

The head amplifier 14 outputs white noise such as that previously described, from the signal path from which the tracking error signal (DPD-TE) is output. The white noise output by the head amplifier 14 is amplified by the servo amplifier 18, which then outputs the amplified white noise to the analog to digital converter 24a. The analog to digital converter 24a executes an analog to digital conversion on the analog signal amplified by the servo amplifier 18 to output, for example, digital data of an 8-bit width to the random number generating unit 24b.

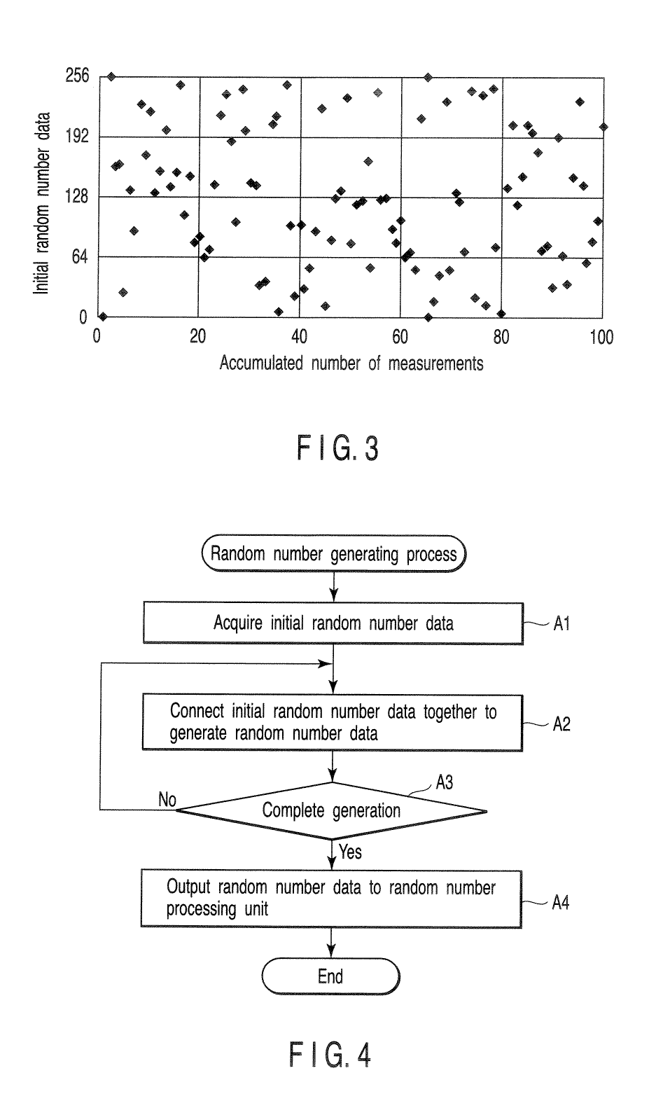

FIG. 3 shows an example of 8-bit digital data generated on the basis of the above scheme and output by the analog to digital converter 24a. FIG. 3 shows 100 measurements obtained using the same timing after power-on (acquisition of data output by the analog to digital converter 24a). As shown in FIG. 3, the values 0 to 256 indicated by 8-bit digital data appear without exhibiting reproducibility.

Once the analog to digital converter 24a generates data based on the white noise, the random number generating unit 24b uses this data (initial random number data) to generate random number data required for the content protecting technique.

When the analog to digital converter 24a has a bit width of 8 bits, the bit width of the initial random number data is smaller than that of random number data required to scramble (cipher) a secret key.

Thus, the random number generating unit 24b executes a random number generating process and uses the initial random number data output by the analog to digital converter 24a to generate random number data required to scramble the secret key.

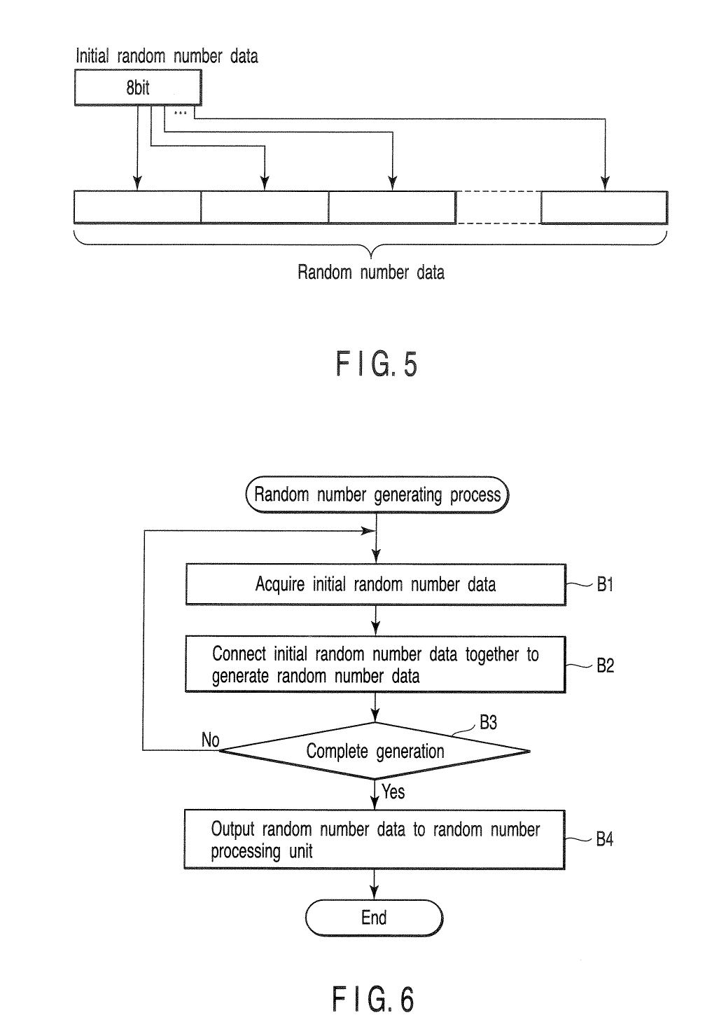

FIG. 4 is a flowchart illustrating a first random number generating process. FIG. 5 is a diagram illustrating the first random number generating process.

The random number generating unit 24b acquires initial random number data of a particular bit width (here, 8 bits) from the analog to digital converter 24a (step A1). The random number generating unit 24b connects the initial random number data together to generate random number data (step A2).

If the random number data does not have a required bit width (step A3, No), the random number generating unit 24b further connects initial random number data together to generate random number data (step A2). The random number generating unit 24b repeatedly connects initial random number data together until the random number data has the required bit width.

Once the random number generating unit 24b completes generating random number data using the initial random number data (step A3, Yes), it outputs the random number data to the random number processing unit 24c (step A4).

The first random number generating process can thus continuously connects together the initial random number data output by the analog to digital converter 24a to generate random number data. This enables the use of only the initial random number data acquired when the analog to digital converter 24a outputs high-grade (non-reproducible) initial random number data.

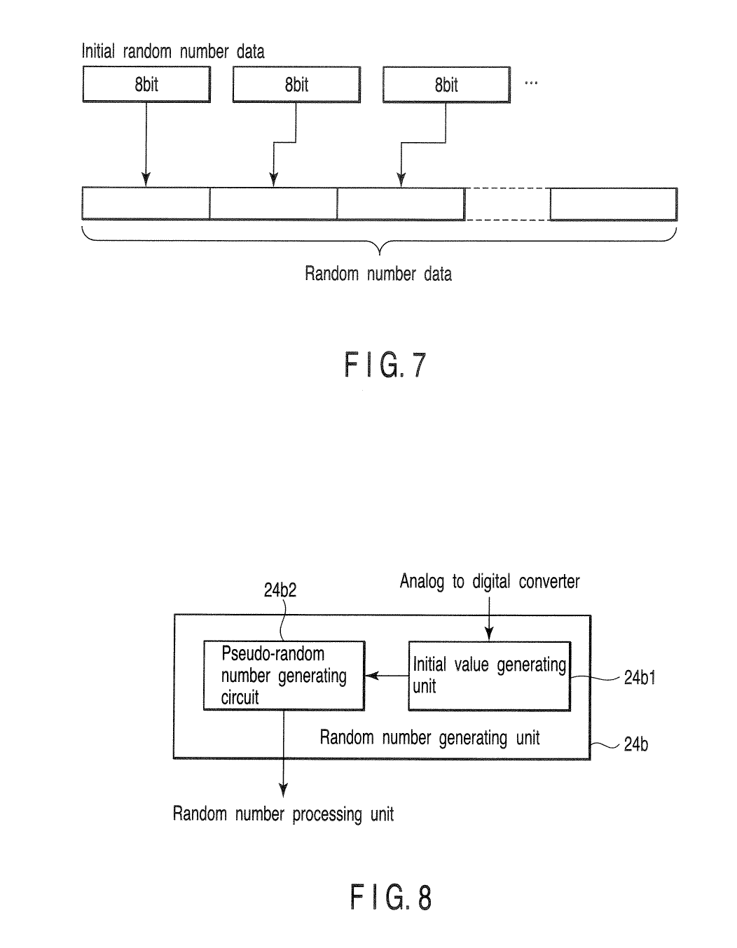

FIG. 6 is a flowchart illustrating a second random number generating process. FIG. 7 is a diagram illustrating the second random number generating process.

The random number generating unit 24b acquires initial random number data of a particular bit width (here, 8 bits) from the analog to digital converter 24a (step B1). The random number generating unit 24b connects the initial random number data together to generate random number data (step B2).

If the random number data does not have a required bit width (step B3, No), the random number generating unit 24b further acquires initial random number data output by the analog to digital converter 24a (step B1). As described above, the random number generating unit 24b connects the initial random number data newly acquired together to generate random number data (step B2). As shown in FIG. 6, the random number generating unit 24b generates random number data by acquiring and repeatedly connecting together initial random number data until the random number data has the required bit width.

Once the random number generating unit 24b completes generating random number data using the initial random number data (step B3, Yes), it outputs the random number data to the random number processing unit 24c (step B4).

The second random number generating process can thus acquire, a plurality of times, initial random number data output by the analog to digital converter 24a and continuously connects the plurality of initial random number data together to generate non-reproducible random number data.

The random number processing unit 24c acquires the key information used for the process using the content protecting technique, from the copy protection unit 24d. The random number processing unit 24c then uses the random number data generated by the random number generating unit 24b to cipher the key information to generate a ciphered key.

The copy protection unit 24d uses the ciphered key generated by the random number generating unit 24c to execute the process for protecting the contents.

Now, description will be given of an example of another configuration of the random number generating unit 24b.

In the above description, the random number generating unit 24b directly uses the data (initial random number data) output by the analog to digital converter 24a to generate random number data. However, pseudo-random number data may be generated on the basis of initial random number data.

FIG. 8 is a block diagram showing the configuration of the random number generating unit 24b that generates pseudo-random number data. As shown in FIG. 8, the random number generating unit 24b is provided with a pseudo-random number generating circuit 24b2 that generates pseudo-random number data on the basis of initial data and an initial value generating unit 24b1 that connects together a plurality of data each of a particular bit width which are output by the analog to digital converter 24a to generate initial data used for the pseudo-random number generating circuit 24b2. The pseudo-random number generating circuit 24b2 is composed of, for example, a combination of logical circuits. The pseudo-random number generating circuit 24b2 generates pseudo-random number data on the basis of initial data input first.

The initial value generating unit 24b1 executes, for example, the first random number generating process, shown in FIG. 4, to generate initial data used for the pseudo-random number generating circuit 24b. Specifically, the initial value generating unit 24b1 serially connects together initial random number data output by the analog to digital converter 24a to generate initial data.

The initial data generated by the initial value generating unit 24b1 is input to the pseudo-random number generating circuit 24b2, which then generates and outputs pseudo-random number data to the random number processing unit 24c. The pseudo-random number generating unit 24b2 uses the non-reproducible initial random number data (generated on the basis of white noise) output by the analog to digital converter 24a, to generate pseudo-random number data. This makes it possible to prevent the pseudo-random number generating circuit 24b2 to output the same random number pattern of pseudo-random number data.

The initial random number data output by the analog to digital converter 24a and generated on the basis of white noise can thus be used as the initial data for the pseudo-random number generating circuit 24b2.

In the above description, the signal path is utilized through which the tracking error signal (DPD-TE) is output. Then, the servo amplifier 18 amplifies white noise input from the signal path and the analog to digital converter 24a executes an analog to digital conversion on the amplified white noise to generate random number data. However, random number data may be generated using the signal path of another signal output by the head amplifier 14.

For example, a signal path can be utilized through which the tracking error signal (PP-TE) based on the push pull method is output. In the signal path of the tracking error signal (PP-TE), the signal is amplified by the servo amplifier 18 and then output to the analog to digital converter 24a, similarly to the tracking error signal (DPD-TE).

Alternatively, the signal path can be utilized through which the focus error signal FE is output. The focus error signal FE is amplified by the servo amplifier 16 and then output to the analog to digital converter 24a. While the laser diode in the pickup head 11 is not driven by the APC 36, white noise is output from the signal path of the focus error signal FE. The white noise input from the signal path is amplified by the servo amplifier 16 and then subjected to an analog to digital conversion by the analog to digital converter 24a. The random number generating unit 24b uses the data output by the analog to digital converter 24a to generate random number data.

Similarly, it is possible to use the signal path of another signal such as the RF signal, addition signal (focus sum signal) LVL, or wobble signal which is output by the head amplifier 14. The amplifier 38 amplifies the signal output from the signal path and outputs the amplified signal to the analog to digital converter 24a. When white noise is output from the signal path, the random number generating unit 24b uses data subjected to an analog to digital conversion by the analog to digital converter 24a to generate random number data. This makes it possible to generate non-reproducible high-grade random number data.

In the above description, random number data is generated on the basis of data output by the analog to digital converter 24a when no light is input to the pickup head 11 (photodetectors 11a, 11b, 11c, and 11d) immediately after power-on of the optical disk device. However, this operation need not necessarily be performed immediately after the power-on. The operation may be performed any time when the head amplifier 14 outputs white noise.

As described above, the conventional circuits (pickup head 11, head amplifier 14, servo amplifiers 16 and 18, amplifier 38, and others) provided in the optical disk device are used regardless of the signal the signal path of which is utilized to generate random number data. This enables non-reproducible high-grade random number data to be generated without the need to add a circuit dedicated to generation of random number data, for example, a circuit serving as a noise source.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk device comprising:
a signal processing unit which processes a signal output by a pickup head;
an amplifying unit which amplifies the signal processed by the signal processing unit;
an analog to digital converting unit which converts the signal concerning a white noise amplified by the amplifying unit into a digital signal to output data of a particular bit width; and
a random number data generating unit which generates random number data on the basis of the data output by the analog to digital converting unit.

2. The optical disk device according to claim 1, wherein the random number data generating unit generates random number data on the basis of the data output by the analog to digital converting unit concerning the white noise output immediate after the optical disk device is powered on.

3. The optical disk device according to claim 1, further comprising a random number processing unit which uses the random number data generated by the random number data generating unit to cipher key information used for a process using a content protecting technique.

4. The optical disk device according to claim 1, wherein the random number data generating unit connects together a plurality of data each of the particular bit width output by the analog to digital converting unit, to generate the random number data.

5. The optical disk device according to claim 1, wherein the random number data generating unit connects together data of the particular bit width output a plurality of times by the analog to digital converting unit, to generate the random number data.

6. The optical disk device according to claim 1, wherein the random number data generating unit comprises:
a pseudo-random number generating unit which generates pseudo-random number data on the basis of initial data; and
an initial value generating unit which connects together a plurality of data each of the particular bit width output by the analog to digital converting unit, to generate the random number data.

7. An optical disk device comprising:
a pickup head having a laser diode;
a signal processing circuit which generates at least a tracking error signal, a focus error signal, and a RF signal on the basis of a signal output by the pickup head;
an first amplifier which amplifies the tracking error signal generated by the signal processing circuit;
an second amplifier which amplifies the focus error signal generated by the signal processing circuit;
an third amplifier which amplifies the RF signal generated by the signal processing circuit;
an analog to digital converter which converts the signal concerning a white noise amplified by the first amplifier, the second amplifier or the third amplifier into a digital signal to output data of a particular bit width; and
a random number data generating unit which generates random number data on the basis of the data output by the analog to digital converting unit.

8. The optical disk device according to claim 7, wherein the random number data generating unit generates random number data on the basis of the data output by the analog to digital converter concerning the white noise output immediately after the optical disk device is powered on and before the laser diode in the pickup head is driven.

9. The optical disk device according to claim 7, wherein the random number data generating unit connects together a plurality of data each of the particular bit width output by the analog to digital converting unit, to generate the random number data.

10. The optical disk device according to claim 7, wherein the random number data generating unit connects together data of the particular bit width output a plurality of times by the analog to digital converting unit, to generate the random number data.

11. A method for generating random number data in an optical disk device having a signal processing unit which processes a signal output by a pickup head and an amplifying unit which amplifies the signal processed by the signal processing unit, the method comprising:
converting the signal concerning a white noise amplified by the amplifying unit into a digital signal to output data of a particular bit width; and
generating random number data on the basis of the output data.
